(19) United States
(12) Patent Application Publication
(10) Pub. No.: US 2011/0087980 A1
(43) Pub. Date: Apr. 14, 2011

(54) METHODS AND SYSTEMS FOR PROVIDING CONTENT

(75) Inventor: Eun Young Lee, Seoul (KR)

(73) Assignee: EIN'S I&S CO., LTD., Port Washington, NY (US)

(21) Appl. No.: 12/902,898

(22) Filed: Oct. 12, 2010

(30) Foreign Application Priority Data
Oct. 14, 2009 (KR) 10-2009-0097911

(51) Int. Cl. G06F 3/048

(52) U.S. Cl. 715/764

(57) ABSTRACT

A method of providing content through a content providing system is provided. The method includes dividing content into objects and associating the divided objects with corresponding codes; storing the objects associated with the codes in a database; accepting a connection of a specific medium among the plurality of media; receiving a request for specific content from the connected specific medium; extracting play environment information including terminal feature information for the connected specific medium; calling a specific object code corresponding to the connected specific medium from a database in consideration of the extracted play environment information; extracting an object corresponding to the called specific object code; creating the specific content by combining the extracted objects; converting the specific content into an image; stacking an interaction layer on the image; and providing the image with the interaction layer stacked thereon to the connected specific medium.

### CROSS-REFERENCE TO RELATED APPLICATION

This application claims the benefit under 35 U.S.C. §119 of Korean Patent Application No. 10-2009-0097911, filed Oct. 14, 2009, which is hereby incorporated by reference in its entirety.

### BACKGROUND

1. Field of the Invention

The present invention relates to a system for providing content and a method of providing content using the content providing system.

2. Discussion of Related Art

With the development of the Internet and the proliferation of mobile telecommunication networks, a multimedia age involving Internet web, Internet protocol television (IPTV), mobile telecommunications, and digital multimedia broadcasting (DMB)is approaching.

Currently, a user accesses content through a variety of media by, for example, connecting to the Internet via a wired or wirelessly connected desktop personal computer (PC) or laptop, accessing a wireless multimedia service (e.g., DMB or mobile multimedia service) via a personal digital assistant (PDA) or mobile phone, and viewing Internet broadcast (e.g., IPTV) via a television (TV).

However, even with the variety of existing media, content available to a user are limited. The user may have limited access to content or may be unable to conveniently obtain desired content through his or her frequently used medium.

Accordingly, there is a need for a scheme of automatically converting content for one medium into content for other media.

### BRIEF SUMMARY

The present invention is directed to a method and system for providing content. Embodiments of the invention are suitable for providing content to a connected medium. Certain embodiments are capable of activating a selected function by creating, via combining a plurality of objects, specific content corresponding to the connected medium, converting the created specific content into an image, stacking an interaction layer on the image, and providing the image to the connected medium.

According to an aspect of the present invention, there is provided a method of providing content through a content providing system that is accessible through a plurality of media, the method including: dividing content into objects and associating the divided objects with corresponding codes; storing the objects associated with the codes in a database; accepting a connection of a specific medium among the plurality of media; receiving a request for specific content from the connected specific medium; extracting play environment information including terminal feature information for the connected specific medium; calling a specific object code corresponding to the connected specific medium from a database in consideration of the extracted play environment information; extracting an object corresponding to the called specific object code; creating specific content by combining the extracted objects; converting the specific content into an image; stacking an interaction layer on the image; and providing the image with the interaction layer stacked thereon to the connected specific medium.

According to another aspect of the present invention, there is provided a system for providing content that is accessible through a plurality of media, the system including: a divider for dividing content into objects and associating the divided objects with corresponding codes; a database for storing the objects associated with the codes; a receiver for receiving a connection signal from a specific medium of the plurality of media and receiving a request for specific content from the connected specific medium; a calling unit for extracting play environment information including terminal feature information for the connected specific medium and calling a specific object code corresponding to the connected specific medium from the database in consideration of the extracted play environment information; a creation unit for extracting objects corresponding to the called specific object code, combining the extracted objects to create specific content, converting the created specific content into an image, and stacking an interaction layer on the image; a transmitter for providing a file of the image with the interaction layer stacked thereon to the connected specific medium; and a controller for accepting a connection to the content providing system through the specific medium, and controlling the divider, the database, the calling unit, the creation unit, and the transmitter.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram for explaining a method of providing content according to an embodiment of the present invention;

FIG. 2 is a block diagram of a content providing system 300 according to an embodiment of the present invention;

FIG. 3 illustrates an example in which content is created for particular media through a content providing system according to an embodiment of the present invention;

FIG. 4 is a flow chart illustrating an example in which content is provided through the content providing system of an embodiment of the present invention;

FIG. 5 illustrates a method of creating specific content by stacking object layers in accordance with an embodiment of the present invention; and

FIG. 6 illustrates an example in which an interaction layer is stacked on an image converted from specific content in accordance with an embodiment of the present invention.

### DETAILED DESCRIPTION

Embodiments of the present invention relate to systems and methods for providing content to a variety of media that may connect to the subject content providing system.

Aspects of the invention can be described in the general context of computer-executable instructions, such as program modules, being executed by a computer, controller, processor, or device. Generally, program modules include routines, programs, objects, components, data structures, etc., that perform particular tasks or implement particular abstract data types. Such program modules can be implemented with hardware components, software components, or a combination thereof. Moreover, those skilled in the art will appreciate that the invention can be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, formats, and numerous other details including operating environments and the like are set forth to provide a thorough understanding of the present invention. In certain instances, structures, devices, and processes are shown in block-diagram form, rather than in detail, to avoid obscuring the present invention. An ordinary-skilled artisan would understand that the present invention may be practiced without these specific details. In addition, although the present specification describes components and functions implemented in certain embodiments with reference to particular standards and protocols, the disclosure is not limited to such standards and protocols. Furthermore, communication between network elements may be wireless or wired. As will be appreciated by those skilled in the art, communication networks may take several different forms and may use several different communication protocols.

As one skilled in the art will appreciate, embodiments of the present invention may be embodied in whole or in part as, among other things: a method, system, or computer-program product. Accordingly, the embodiments may take the form of a hardware embodiment, a software embodiment, or an embodiment combining software and hardware.

Certain embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

Hereinafter, a method of providing content through a content providing system will be described with reference to the accompanying drawings.

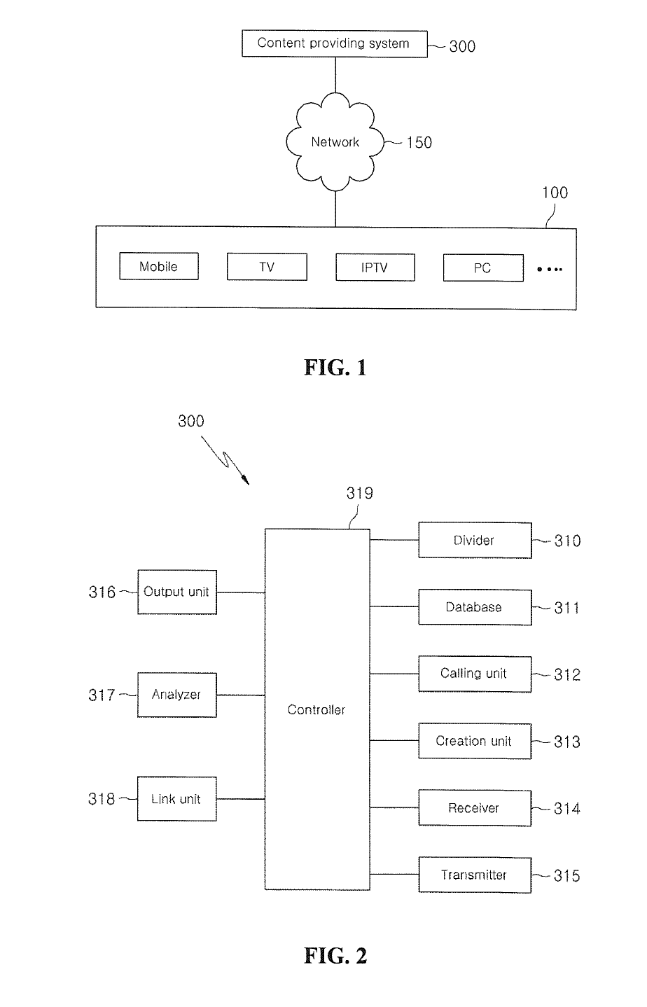

FIG. 1 is a block diagram for explaining a method of providing content according to an exemplary embodiment of the present invention.

A content providing system 300 according to an exemplary embodiment of the present invention may be accessed through a specific medium 100 over a network 150. The network 150 refers to a network that performs communication through a medium, such as the Internet, a wireless communication network, a broadcasting network, and the like.

The specific medium 100 may include one or more of a variety of terminals that can connect to the content providing system 300. For example, the terminal of the specific medium 100 can include, but is not limited to, a mobile terminal, a TV, an IPTV, or a desktop PC.

In accordance with an embodiment of the invention, the content providing system 300 can be accessed through a plurality of media. Accordingly, the content providing system 300 may provide content via multimedia. Providing the content can include, but is not limited to displaying the content and transmitting the content.

The plurality of media that may access the content providing system 300 can include, but are not limited to, TV, IPTV, mobile telecommunication, Internet web, and DMB.

The TV of the media refers to a medium for receiving a broadcast signal from a broadcasting system, demodulating the received broadcast signal, and displaying image and voice information. The TV may include an analog TV using an analog signal and a digital TV using a digital signal.

The IPTV of the media is a service of providing broadcasting channels, video on demand (VOD), bidirectional data service, and the like, on a single terminal using high-speed Internet. The IPTV service can be provided via collection of contents from a content provider (CP), a program provider (PP), and the like. The IPTV service can also include processing of the content, determination of a content format for compression for smooth transmission to an IPTV network, copyright protection for a copyright holder, and content protection for preventing illegal distribution. In an exemplary embodiment of the present invention, the IPTV is not a simple Internet TV, but a medium for transmitting dedicated content designed to be controlled by a remote control rather than a keyboard.

The mobile telecommunication of the media can include second-generation mobile telecommunication such as global system for mobile telecommunication (GSM) and code division multiple access (CDMA); third-generation mobile telecommunication such as global system for mobile telecommunication (WCDMA), CDMA2000, high speed downlink packet access (HSDPA), and high speed uplink packet access (HSUPA); and next-generation mobile telecommunication such as Wibro and long term evolution (LTE). The mobile telecommunication is a medium for transmitting dedicated content designed to be suitable for a relatively small screen of a mobile phone.

The Internet web of the media is a medium for transmitting documents created in markup language, such as hyper text markup language (html), extended markup language (xml), and standard generalized markup language (sgml), using hypertext transfer protocol (http) or transmission control protocol-internet protocol (TCP/IP).

The DMB of the media includes territorial DMB and satellite DMB. The DMB is a medium for transmitting dedicated content designed to be suitable for a relatively small screen of a portable DMB terminal.

Throughout this disclosure, “content corresponding to a medium” refers to content optimized to be readily played through the medium. For example, content corresponding to the Internet web is created using markup language (e.g., html and xml), script language (e.g., java script), or an add-in program (e.g., active x and ocx), and transmitted through TCP/IP. Content corresponding to the mobile telecommunication is a simplified version of the Internet web content for a mobile telecommunication terminal and is transmitted via a wireless application protocol (WAP). Content corresponding to the IPTV refers to a multimedia file encoded by MPEG-2, MPEG-4, WMV-9, H.264, or the like. Content corresponding to the DMB is a multimedia file encoded by MPEG-2 or MPEG-4 and has a relatively smaller size than the content corresponding to the IPTV. Although particular protocols are listed herein, it should be understood that other protocols may be used for these and other media.

FIG. 2 is a block diagram of a content providing system 300 according to an exemplary embodiment of the present invention. As shown in FIG. 2, the content providing system 300 of one exemplary embodiment includes a divider 310, a database 311, a calling unit 312, a creation unit 313, a receiver 314, a transmitter 315, an output unit 316, an analyzer 317, a link unit 318, and a controller 319. In certain implementations of the content providing system 300, some of the components may be omitted or combined. In other implementations of the content providing system 300 other components may be added to perform similar or additional functions.

According to a specific embodiment, the divider 310 divides content into objects. As described herein, an object refers to an element of the content. For example, when the content is an article consisting of an image and a text, upon division of the article into objects, the image can be considered one object and the text can be considered another object. Alternately, the image and the text can be considered a single object. In a further embodiment, the image can be divided into a first image area and a second image area. In such an embodiment, the first image area and the second image can each be an object.

According to an embodiment of the invention, the divider 310 can also associate the divided objects with specific codes. In one embodiment, the divider 310 can associate an attribute of each object with a specific code. For example, object A may be associated with code A and object B may be associated with code B. As described herein, an attribute of an object refers to an essential feature for identifying a particular object from other objects. The load of the content providing system 300 can be minimized by extracting the attribute of a particular object and associating only the attribute with the specific code, instead of associating every feature of the particular object with specific codes.

For one example illustrating minimizing the load of the content providing system 300, content 1 can be defined as object A, object B, and object C, and content 2 can be defined as object A, object B, and object D. For the case where the content is stored in the database 311 in units of content, content 1 (object A+object B+object C) and content 2 (object A+object B+object D) are stored in the database 311, resulting in object A and object B being stored multiple times due to overlapping content. However, for the case where content is divided into objects and the divided objects and specific codes associated with the divided objects are stored in the database 311, only object A, object B, object C, object D, and code information associated with the objects are stored in the database 311. Thus, where content is created and stored using the division of the content into objects, an amount of information or data stored in the database 311 can be reduced.

By dividing the content into objects and storing the objects, the loading time necessary for providing the content can be reduced.

Meanwhile, where the objects are associated with the specific codes as described above, tracking information for each object can be calculated by checking the tracking of each code. The tracking information for the object refers to information related to a trace of the object. The tracking information can include, for example, an extraction number of the object, information on a movement path of the extracted object, conversion information for the extracted object, etc.

According to an exemplary embodiment of the present invention, the content providing system 300 can check the tracking of each code by numbering each code to correspond to a code extraction number. First extracted object A may be associated with code “A_{—}0001” and second extracted object A may be associated with code “A_{—}0002.” Accordingly, the extraction number of each object can be checked from the numerals (e.g., 0001 and 0002) subsequent to a code (e.g., “A” for object A) associated with an object attribute.

According to a specific embodiment, the database 311 is a space provided by a storage device or medium in which various items of information are stored. For example, specific content may be stored in the database 311. The specific content can include, but is not limited to, articles about a particular brand, moving pictures, images, details about products, an article about products, images of products, and moving pictures of products. In particular, objects constituting the specific content can be stored in the database 311 in association with specific codes.

In one embodiment, the calling unit 312 extracts play environment information for a connected specific medium 100. The play environment information may be extracted from information stored in the database 311 or received from the connected specific medium 100. The play environment information can include, for example, terminal feature information for the connected specific medium 100 and user play-preference feature information. The terminal feature information can include, for example, decoding performance information and display information for the connected medium. The user play-preference feature information is information on user-specific play preferences and preference ratings, which result from user preference or terminal performance. Where content is a moving picture or a still picture photographed by a virtual camera and displayed, the user play-preference feature information may include information on a focal distance of the virtual camera, information related to a camera location in a three-dimensional virtual scene, information related to a location directed by the virtual camera in the three-dimensional virtual scene, etc. Further, the calling unit 312 can call a specific object code corresponding to the connected specific medium from the database 311 in consideration of the extracted play environment information.

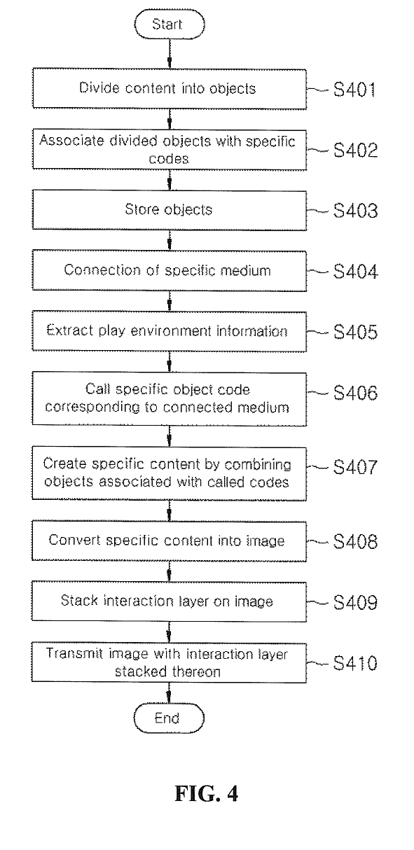

According to an embodiment, the creation unit 313 extracts objects corresponding to the specific object code called by the calling unit 312 and combines the extracted objects to create specific content. Further, the creation unit 313 can serve to convert the created specific content into an image. The creation unit 313 can also stack an interaction layer on the image. As described herein, an interaction layer refers to an interface for performing a specific function. For example, the interaction layer can be a layer having a specific function set for bidirectional communication. The bidirectional communication includes communication between the specific medium 100 and the content providing system 300. A method of creating content by combining objects will be described in more detail below with respect to FIGS. 4-6.

According to an embodiment, the receiver 314 can receive a variety of signals and content. For example, the receiver 314 can receive a connection signal from a specific medium or content from a content provider. The received connection signal can be delivered to and analyzed by the controller 319. The controller 319 can be configured to analyze the connection signal in order to confirm the type, the location information, and the user information of the connected medium. The controller 319 can also determine whether to accept a connection of the specific medium based on the analyzed information. Once the connection is accepted, the content providing system 300 can perform data communication with the connected medium 100.

Meanwhile, the receiver 314 can also include a reception path (not shown) corresponding to each connected medium. For example, a connection signal via a mobile device may be received through a first reception path, a connection signal via an Internet web may be received through a second reception path, and a connection signal via a TV may be received through a third reception path. In addition to the connection signal of a connected medium, the receiver 314 can also receive specific data through the reception path corresponding to the connected medium from the connected medium.

According to an embodiment, the transmitter 315 transmits content (including the image with the interaction layer stacked thereon) stored in the database 311 or link information for accessing other content stored in the database 311 to an external space. The external space refers to a space other than the content providing system 300. For example, the external space can include, but is not limited to, a user terminal, an advertiser terminal, or a specific web site (or a specific web server). The external space can include an external user space. An external user space refers to a space associated with a user, which is provided by a system external to the content providing system 300. For example, the external user space can include, but is not limited to, a mini homepage, a blog, or an E-mail of a specific user.

The transmitter 315 can also transmit specific data (e.g., the content, the image with the interaction layer stacked thereon, or the link information) in consideration of the medium connected to the content providing system 300 under control of the controller 319. For example, the transmitter 315 can transmit mobile content to the mobile terminal and TV content to the TV.

Meanwhile, the transmitter 315 can include a transmission path (not shown) corresponding to each connected medium. For example, data transmitted to a mobile device may be transmitted through a first transmission path, data transmitted to an Internet web may be transmitted through a second transmission path, and data transmitted to a TV may be transmitted through a third transmission path.

According to an embodiment, the output unit 316 outputs a screen for various items of information. For example, the output unit 316 can display a screen for a search result matching an input keyword, a screen for content search, a screen for play of specific content, etc., depending on the situation.

According to an embodiment, the analyzer 317 analyzes a user activity history to produce user activity pattern information. For example, the analyzer 317 can analyze the user activity history by analyzing activity pattern information fed back from an Internet uniform resource locator (URL), an IPTV operating system, and a mobile telecommunication system. In another embodiment, the analyzer 317 can analyze the user activity history by analyzing, for example, a number of uses (or accesses) of a particular content or a specific object constituting the particular content stored in the content providing system 300. The analyzer 317 can produce reaction information for content or a specific object by analyzing the reaction to the content. Examples of reaction information can include a scraping number (e.g., the number of times a particular content is copied/re-used) and the number of comments for particular content or a particular object provided by the content providing system 300 and an edit number of the particular content (e.g., number of times a content is edited).

According to an embodiment, the link unit 318 provides a link to a particular space based on corresponding link information. The link information refers to information for a link to the specific space, such as URL information. The specific space linked by the link information may be inside or outside the content providing system 300.

According to an embodiment, the controller 319 can control the functions of the divider 310, the database 311, the calling unit 312, the creation unit 313, the receiver 314, the transmitter 315, the output unit 316, the analyzer 317, and the link unit 318.

Hereinafter, a method of creating specific content through division of content into objects in accordance with an embodiment of the invention will be described in greater detail.

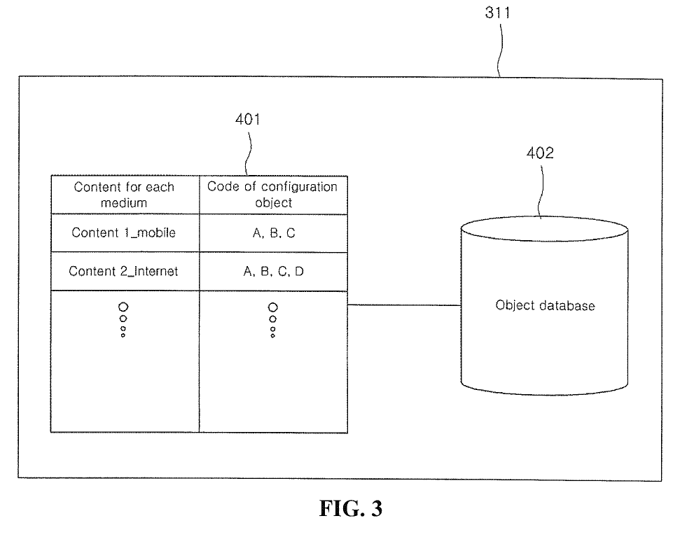

FIG. 3 illustrates an example in which content is created for connected media through the content providing system 300 according to an exemplary embodiment of the present invention.

As shown in FIG. 3, where content is divided into objects, the divided objects can be combined according to the nature of a particular medium in order to create specific content. The created specific content can then be provided to a user and/or converted into an image. According to one embodiment, the database 311 can include a mapping table 401 for objects constituting the content and an object database 402 in which the divided objects are stored. As one example, the calling unit 312 can call object configuration codes A, B, and C to provide mobile content 1 (Content 1_mobile). Here, the object configuration code refers to the particular codes associated with the divided specific object. When the object configuration codes A, B, and C are called, the creation unit 313 extracts the objects associated with the called codes from the object database 402 and combines the objects to create the specific content. As another example, the calling unit 312 can call object configuration codes A, B, C, and D to provide Internet content 1 (Content 1_Internet). When the object configuration codes A, B, C, and D are called, the creation unit 313 extracts the objects associated with the called codes from the object database 402 and combines the objects to create the specific content. The difference in the configuration objects between mobile content 1 (Content 1_mobile) and Internet content 1 (Content 1_Internet) (i.e., the addition of code D for the Internet content) is due to the medium-specific environment. For example, since media have different decoding capabilities, play capabilities, and/or display sizes, the object configuration codes constituting the content may differ. The plurality of contents created as described above can be provided to respective media.

FIG. 4 is a flow chart illustrating an example in which content is provided using the content providing system 300 in accordance with an embodiment of the invention.

Referring to FIG. 4, media content can be divided into objects (S401). In one embodiment, the divider 310 divides the content into objects. For example, when the content is an article consisting of an image and text, the divider 310 may regard the image and the text as separate objects and divide the content into the image and the text. As another example, when the content includes a plurality of images, the divider 310 may regard each of the respective images as objects and divide the content into the images.

The divided objects can be associated with specific codes (S402). In one embodiment, the divider 310 can associate the divided objects with the specific codes. In a specific embodiment, the divider 310 associates an attribute of each object with a specific code.

The object associated with the specific code can be stored, for example, in the database 311 (S403). The object associated with the specific code can be stored in the database 311 as described with respect to FIG. 3.

During use of the content providing system 300, a specific medium can be connected to the content providing system (S404). According to one embodiment, the receiver 314 can receive a connection signal from a specific medium. When the receiver 314 receives the user connection signal from the specific medium, the controller 319 can determine whether to accept the connection. For example, the controller 319 can analyze the connection signal to confirm the type, the location information, and/or the user information of the connected medium. The controller 319 can then determine whether to accept a connection of the specific medium based on the analysis result. If the user connection is determined to be acceptable (e.g., normal or allowable), the controller 319 can accept the user connection made through the specific medium.

The receiver 314 can also receive a request for specific content from the connected medium 100. The request for specific content may refer to a request for content optimized for the connected medium 100. Accordingly, when the connected medium is a mobile device, the request for specific content is a request for content optimized for the mobile environment (e.g., a specific moving picture optimized for the mobile environment).

Upon receipt of the request for specific content, the calling unit 312 can extract play environment information for the connected specific medium (S405). The play environment information can include terminal feature information for the connected specific medium 100, user play-preference feature information, and so on. When the play environment information is previously stored in the database 311, the calling unit 312 can extract the play environment information from the database 311. Alternatively, the calling unit 312 can extract the play environment information through the connected medium 100.

After the play environment information is extracted, specific object code corresponding to the connected medium is called (S406). For example, when the play environment information for the connected medium is extracted, the calling unit 312 can then call a specific object code from the database 311 in consideration of the extracted play environment information.

Specific content can be created by combining objects associated with the called object codes (S407). According to an embodiment, the creation unit 313 can create specific content by combining objects associated with the called codes. There are several methods of creating specific content through combination of objects that can be used. In one embodiment, specific content is created by stacking object layers.

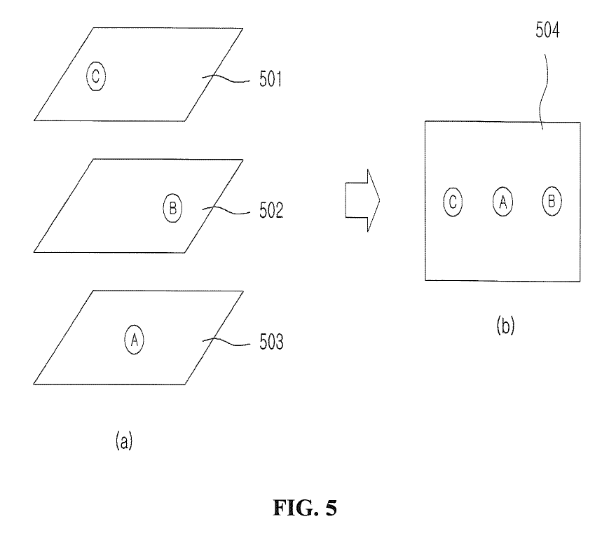

FIG. 5 illustrates a method of creating specific content by stacking object layers in accordance with one embodiment of the invention.

In FIG. 5(a), a process of stacking a first object layer 503 including object “A”, a second object layer 502 including object “B”, and a third object layer 501 including object “C” is illustrated. Although one object is shown included for each of the object layers 501, 502 and 503, a plurality of objects may be included in each object layer.

FIG. 5(b) illustrates one specific content 504 formed by stacking the object layers 501, 502 and 503 shown in FIG. 5(a). The specific content 504 can be formed of layers. That is, the specific content 504 can be created by stacking a plurality of object layers. A process of combining objects by stacking the object layers can be conveniently performed.

Once the specific content is created, the specific content can be converted into an image (S408). In one embodiment, the creation unit 313 can convert the specific content created by the stacking of the object layers into an image. The image conversion can reduce a size of the specific content.

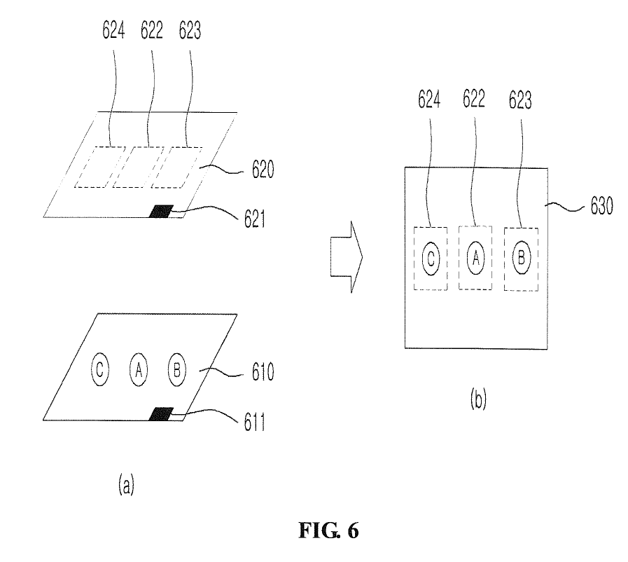

The creation unit 313 can also be used to stack an interaction layer on the image converted from the specific content (S409). A method of stacking an interaction layer on an image will be described with reference to FIG. 6.

FIG. 6 illustrates an example in which an interaction layer is stacked on an image converted from the specific content in accordance with an embodiment of the invention.

In FIG. 6(a), a layer 610 indicates an image converted from specific content created by combining a plurality of objects. That is, the layer 610 indicates the image compressed from the specific content. A layer 620 indicates an interaction layer. Functions interworking with specific menus may be set in predetermined areas 622, 623 and 624 of the layer 620. The layer 620 can be implemented transparently for display of the specific content stacked below. When the layer 620 is implemented transparently, the object included in the layer 610 can be more clearly accessed or viewed.

The specific menu provided by the interaction layer 620 can include a function for a link to a specific screen based on link information related to a particular object among the objects constituting the specific content. The link information can include information for a link to a space from which content first created using the specific object can be accessed, information for a link to a space where goods of a specific brand related to a particular object can be purchased, information for a link to a space from which an object associated with the particular object can be accessed, etc.

Further, at least one of settings, locations, and sizes of the predetermined areas 622, 623, and 624 of the layer 620 may be fixed irrespective of a state of the layer 610, and can also vary with the state of the layer 610. For example, object arrangement information 611 indicating arrangement information for an object can be inserted into the layer 610. The object arrangement information 611 can be implemented as a bar code. A unit 621 capable of reading the object arrangement information 611 can be included in an area of the layer 620. In this case, at least one of the settings, the locations, and the sizes of the predetermined areas 622, 623, and 624 of the layer 620 can vary with an object arrangement state read by the unit 621. As shown in FIG. 6(b), a layer 630 is obtained by stacking the layer 610 and the layer 620.

Meanwhile, according to a further embodiment of the present invention, although not shown, when specific content has a plurality of object layers, an interaction layer forming a pair with each object layer can be stacked. In this case, each object layer can be converted into an image and be stacked with an interaction layer.

The layer 630 which has the image and the interaction layer stacked thereon can be transmitted to the connected specific medium 100 by the transmitter 315 (S410).

According to one embodiment, a user of the connected specific medium 100 can then select particular specific content from the received layer 630 and activate a specific menu function. That is, the user can select requested specific content from the image of the layer 630, and activate a function by selecting the area of the interaction layer in which the function is set. For example, where the function is for a link to a space where the user can purchase goods related to a specific object and the function has an area set in the interaction layer (where specific link information is inserted), the user can select the link to the space where the user can purchase the goods related to the specific object, by selecting the predetermined area of the interaction layer.

According to an exemplary embodiment of the present invention, embodiments of the above-described method can be implemented as computer readable codes in a computer-readable medium. The computer-readable medium can include all types of recording media in which computer-readable data are stored. Examples of the computer-readable medium include a ROM, a RAM, a CD-ROM, a magnetic tape, a floppy disk, and an optical data storage. Further, the recording medium may be implemented in the form of a carrier wave (e.g., Internet transmission).

Accordingly, the present disclosure contemplates a machine readable medium containing instructions, or that which receives and executes instructions from a propagated signal so that a device connected to a network environment can send or receive voice, video or data, and communicate over the network using the instructions. The instructions can further be transmitted or received over a network via a network interface device. While the machine/computer-readable medium may be described in an exemplary embodiment to be a single medium, the term “computer-readable medium” or “machine-readable medium” should be taken to include a single medium or multiple media (e.g., a centralized or distributed database, and/or associated caches and servers) that store the one or more sets of instructions. The term “computer-readable medium” or “machine-readable medium” shall also be taken to include any medium that is capable of storing, encoding, or carrying a set of instructions for execution by the machine and that cause the machine to perform any one or more of the methodologies described herein. The term “computer-readable medium” or “machine-readable medium” shall accordingly be taken to include, but not be limited to: solid-state memories such as a memory card or other package that houses one or more read-only (non-volatile) memories, random access memories, or other re-writable (volatile) memories; and magneto-optical or optical medium such as a disk or tape. Accordingly, the disclosure is considered to include any one or more of a machine/computer-readable medium or a distribution medium, as listed herein and including art-recognized equivalents and successor media, in which the software implementations herein are stored. In certain embodiments, non-transitory media are used.

In a method and system for providing content according to an exemplary embodiment of the present invention, a particular content can be rapidly and conveniently converted into content corresponding to a variety of media and provided to one or more of the variety of media.

According to an exemplary embodiment of the present invention, since specific content corresponding to a connected medium can be created by combining a plurality of objects and converting the combined plurality of objects into an image, the size of the specific content transmitted to the connected medium can be reduced.

Furthermore, according to an exemplary embodiment of the present invention, by stacking an interaction layer on the image converted from the combined plurality of objects of the specific content and providing the image with the stacked interaction layer to the connected specific medium, the content providing system can bidirectionally communicate with a user of the content.

The content providing system and method as described above are not limited to the exemplary embodiments and some or all of the exemplary embodiments may be selectively combined for various variations of the present invention. Any reference in this specification to “exemplary embodiment,” “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

What is claimed is:

1. A method of providing content through a content providing system that is accessible through a plurality of media, the method comprising:
dividing content into objects and associating the divided objects with corresponding codes;
storing the objects associated with the codes in a database;
accepting a connection of a specific medium among the plurality of media;
receiving a request for specific content from the connected specific medium;
extracting play environment information including terminal feature information for the connected specific medium;
calling specific object codes corresponding to the connected specific medium from the database in consideration of the extracted play environment information;
extracting objects corresponding to the called specific object codes;
creating specific content by combining the extracted objects;
converting the created specific content into an image;
stacking an interaction layer on the image; and
providing the image with the interaction layer stacked thereon to the connected specific medium.

2. The method of claim 1, wherein the creating of the specific content by combining the extracted objects comprises stacking a plurality of layers, each layer including at least one object.

3. The method of claim 1, wherein the creating of the specific content by combining the extracted objects comprises stacking layers in units of objects.

4. The method of claim 1, wherein the image produced through the converting of the created specific content does not exceed a maximum width of a display dimension for the connected specific medium.

5. The method of claim 1, wherein the play environment information further comprises user play-preference feature information.

6. The method of claim 1, wherein the interaction layer comprises a function interworking with a specific menu set in a predetermined area of the interaction layer.

7. The method of claim 6, wherein the interaction layer is implemented transparently on the image.

8. The method of claim 6, wherein the specific menu comprises a function for a link to a specific screen based on link information related to a particular object among the extracted objects.

9. The method of claim 8, wherein the link information comprises information for a link to a space where goods of a specific brand related to the particular object can be purchased.

10. A system for providing content that is accessible through a plurality of media, the system comprising:
a divider for dividing content into objects and associating the divided objects with corresponding codes;
a database for storing the objects associated with the codes;
a receiver for receiving a connection signal from a specific medium of the plurality of media and receiving a request for specific content from a connected specific medium;
a calling unit for extracting play environment information including terminal feature information for the connected specific medium and calling specific object codes corresponding to the connected specific medium from the database in consideration of the extracted play environment information;
a creation unit for extracting objects corresponding to the called specific object codes, combining the extracted objects to create the specific content, converting the created specific content into an image, and stacking an interaction layer on the image;
a transmitter for providing a file of the image with the interaction layer stacked thereon to the connected specific medium; and
a controller for accepting a connection of the specific medium to the content providing system, and controlling the divider, the database, the calling unit, the creation unit, and the transmitter.

11. The system of claim 10, wherein the creation unit stacks a plurality of layers, each including at least one object, to create the specific content.

12. The system of claim 10, wherein the creation unit combines the extracted objects by stacking layers in units of object to create the specific content.

13. The system of claim 10, wherein the controller performs a control so that the created image does not exceed a maximum width of a display dimension for the connected specific medium.

14. The system of claim 10, wherein the play environment information further comprises user play-preference feature information.

15. The system of claim 10, wherein the interaction layer comprises a function interworking with a specific menu set in a predetermined area of the interaction layer.

16. The system of claim 15, wherein the interaction layer is implemented transparently on the image.

17. The system of claim 15, wherein the specific menu comprises a function for a link to a specific screen based on link information related to a particular object among the extracted objects.

18. The system of claim 17, wherein the link information comprises information for a link to a space where goods of a specific brand related to the particular object can be purchased.

19. The system of claim 15, further comprising a link unit, wherein the link unit provides the link to the specific screen based on the link information related to the particular object among the extracted objects, wherein the controller controls the link unit.

20. The system of claim 15, further comprising:
an output unit for providing a display screen; and
an analyzer for analyzing a user activity history and produce user activity pattern information,
wherein the controller controls the output unit and the analyzer.
